(19) United States
(12) Patent Application Publication
(10) Pub. No.: US 2024/0169070 A1
(43) Pub. Date: May 23, 2024

(54) INFORMATION ANALYSIS APPARATUS, INFORMATION ANALYSIS METHOD, AND COMPUTER-READABLE RECORDING MEDIUM

(71) Applicant: NEC Corporation, Minato-ku, Tokyo (JP)

(72) Inventors: Shunichi KINOSHITA, Tokyo (JP); Masaru Kawakita, Tokyo (JP)

(73) Assignee: NEC Corporation, Minato-ku, Tokyo (JP)

(21) Appl. No.: 18/282,889

(22) PCT Filed: Mar. 23, 2021
(86) PCT No.: PCT/JP2021/011986

§ 371 Date: Sep. 19, 2023

(51) Int. Cl. G06F 21/57; G06F 40/40

(52) U.S. Cl. CPC G06F 21/577; G06F 40/40

(57) ABSTRACT

An information analysis apparatus includes: a technical information extracting unit that extract feature information indicating a characteristic item in a cyberattack, from a news article; and a feature information associating unit that extract, from a database storing technical information regarding a cyberattack that has already occurred, technical information related to the extracted feature information, and associates the extracted feature information and the extracted technical information with each other.

### TECHNICAL FIELD

The present invention relates to an information analysis apparatus and an information analysis method for analyzing information regarding a cyberattack, and in particular relates to a computer-readable recording medium in which a program for realizing the information analysis apparatus and the information analysis method is recorded.

### BACKGROUND ART

In recent years, systems in government agencies, business enterprises, and the like have been often targeted by cyberattacks, and it has become very important to ensure the security of the systems. Therefore, in system operations, there is a need to collect information regarding vulnerability of the system and, in addition, information regarding cyberattacks such as information regarding the tactics of attacks, and to take necessary measures using such information. In addition, there is a need to invest in the system in order to take measures for ensuring security, and thus information regarding cyberattacks also needs to be collected for business decision-making.

In view of this, technical information regarding cyberattacks (event information) is shared. The technical information regarding cyberattacks includes the names of software used in attacks, Common Vulnerabilities and Exposures (CVE) IDs, tactics of attacks, and the like. Also, such information may be structured or may be written in natural language. Non-patent Document 1 discloses a technique for extracting information regarding cyberattacks from security reports written in natural language. Here, the security reports are mainly reports that are provided by security vendors that provide software development and related services for security measures.

Note that, with the technique disclosed in Non-patent Document 1, there is a problem in that it is not possible to obtain characteristic information regarding cyberattacks such as the victims and the cost of damage. Such characteristic information is required particularly for business decision-making such as that described above.

On the other hand, Patent Document 1 discloses a system for specifying important feature words from the latest news articles. This system calculates a similarity between feature words extracted from the latest news articles and feature words extracted from existing past news articles, and tags feature words that have a higher similarity out of the former feature words.

### LIST OF RELATED ART DOCUMENTS

### Patent Document

Patent Document 1: Japanese Patent Laid-Open Publication No. 2010-224622

### Non Patent Document

Non-patent Document 1: Shunta Nakagawa, Tatsuya Nagai, Hideaki Kanehara, Keisuke Furumoto, Makoto Takita, Yoshiaki Shiraishi, Takeshi Takahashi, Masami Mohri, Yasuhiro Takano, Masakatsu Morii, “Extraction of event information from security reports for modeling threat information”, IEICE Technical Report, vol. 118, no. 486, ICSS2018-78, pp. 89-94, March 2019

### SUMMARY OF INVENTION

### Problems to be Solved by the Invention

It is conceivable that, if the above-described system disclosed in Patent Document 1 is applied to the field of security, important feature words related to cyberattacks can be specified from articles on security. However, in the above-described system disclosed in Patent Document 1, feature words are merely specified, and it is difficult to specify technical information regarding a cyberattack such as the name of software used in the attack, a CVE (Common Vulnerabilities and Exposures) ID, and the tactics of the attack when such information is not explicitly included in an article. The above-described system disclosed in Patent Document 1 has a problem in that detailed information regarding a cyberattack cannot be obtained.

An example object of the invention is to provide an information analysis apparatus, an information analysis method, and a computer-readable recording medium that can obtain characteristic information regarding a cyberattack along with technical information regarding a cyberattack.

### Means for Solving the Problems

In order to achieve the above-described object, an information analysis apparatus includes: a feature information extracting unit that extract feature information indicating a characteristic item in a cyberattack, from a news article; and a feature information associating unit that extract, from a database storing technical information regarding a cyberattack that has already occurred, technical information related to the extracted feature information, and associates the extracted feature information and the extracted technical information with each other.

In order to achieve the above-described object, an information analysis method includes:

a feature information extracting step of extracting feature information indicating a characteristic item in a cyberattack, from a news article; and

a feature information associating step of extracting, from a database storing technical information regarding a cyberattack that has already occurred, technical information related to the extracted feature information, and associating the feature information and the technical information with each other.

In order to achieve the above-described object, a computer readable recording medium according to an example aspect of the invention is a computer readable recording medium that includes recorded thereon a program,

the program including instructions that cause the computer to carry out:

a feature information extracting step of extracting feature information indicating a characteristic item in a cyberattack, from a news article; and

a feature information associating step of extracting, from a database storing technical information regarding a cyberattack that has already occurred, technical information related to the extracted feature information, and associating the feature information and the technical information with each other.

### Advantageous Effects of the Invention

As described above, according to the invention, it is possible to obtain characteristic information regarding a cyberattack along with technical information regarding a cyberattack.

### BRIEF DESCRIPTION OF THE DRAWINGS

FIG. 1 is a configuration diagram illustrating the schematic configuration of the information analysis apparatus according to the example embodiment.

FIG. 2 is a configuration diagram specifically illustrating the configuration of the information analysis apparatus according to the example embodiment.

FIG. 3 is a flowchart illustrating operations of the information analysis apparatus according to the example embodiment.

FIG. 4 is a diagram illustrating an example of a news article, an example of technical information, and an example of a result of associating feature information and technical information with each other.

FIG. 5 is a configuration diagram illustrating a configuration of the modified example of the information analysis apparatus according to the example embodiment.

FIG. 6 is a block diagram illustrating an example of a computer that realizes the information analysis apparatus according to the example embodiment.

### EXAMPLE EMBODIMENT

### Example Embodiment

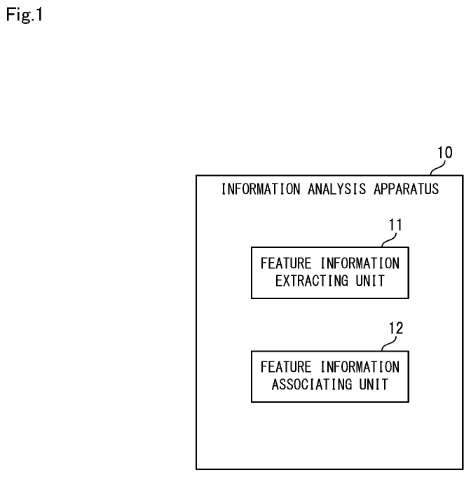

An information analysis apparatus, an information analysis method, and a program according to an example embodiment will be described below with reference to FIGS. 1 to 6.

[Apparatus Configuration]

First, a schematic configuration of the information analysis apparatus according to the example embodiment will be described with reference to FIG. 1. FIG. 1 is a configuration diagram illustrating the schematic configuration of the information analysis apparatus according to the example embodiment.

An information analysis apparatus 10 according to the example embodiment illustrated in FIG. 1 is an apparatus for analyzing information regarding a cyberattack. As illustrated in FIG. 1, the information analysis apparatus 10 includes a feature information extracting unit 11 and a feature information associating unit 12.

The feature information extracting unit 11 extracts, from a news article on a cyberattack, feature information indicating characteristic items of the cyberattack. The feature information associating unit 12 extracts technical information regarding a cyberattack related to the feature information extracted by the feature information extracting unit 11, from a database in which technical information regarding cyberattacks that have already occurred is stored, and associates the feature information and the technical information with each other. Note that, hereinafter, technical information regarding a cyberattack will be referred to as “technical information”, and the aforementioned database will be referred to as “technical information database”.

As described above, according to the example embodiment, feature information extracted from a news article and technical information are associated with each other, and thus it is possible to obtain feature information and technical information related to the feature information, at the same time.

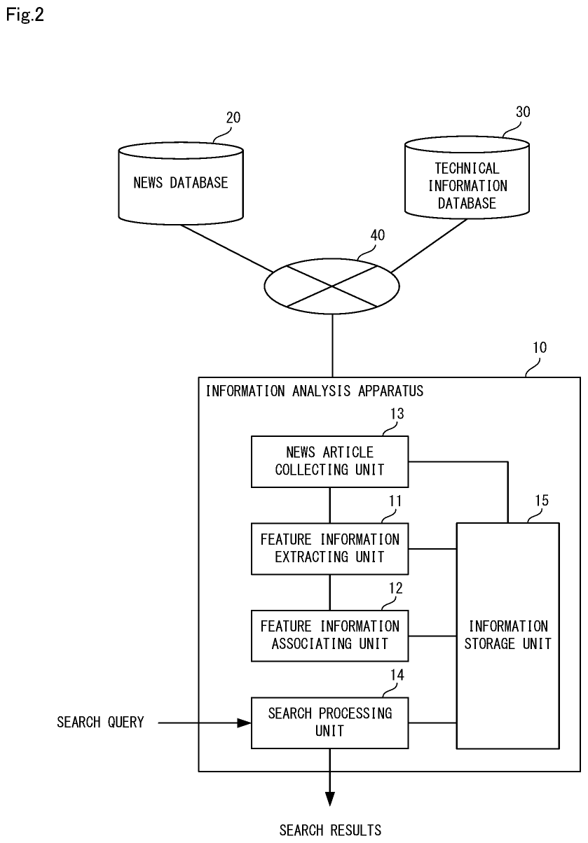

Next, the configuration and functions of the information analysis apparatus according to the example embodiment will be described in detail with reference to FIG. 2. FIG. 2 is a configuration diagram specifically illustrating the configuration of the information analysis apparatus according to the example embodiment.

As illustrated in FIG. 2, in the example embodiment, the information analysis apparatus is connected to a news database 20 and a technical information database 30 via a network 40 such as the Internet in a manner that enables data communication.

The news database 20 is a database in which news articles provided on the Internet are stored. The stored news articles are read out by a Web server, and are presented on a Web site. Note that only a single news database 20 is illustrated in the example in FIG. 2, but there are a large number of news databases 20 in actuality.

The technical information database 30 is a database in which technical information is stored as described above. In the example embodiment, technical information is trace information of a cyberattack (IoC: Indicator of Compromise), for example. The IoC includes information regarding the vulnerability of an attacked system (Common Vulnerability and Exposure: CVE), the name of software used in the cyberattack, the tactics of the cyberattack, and the like. Furthermore, in the technical information database 30, technical information may be associated with each other. The names of software used in cyberattacks and the common vulnerabilities and exposures used by the software may be stored in association with each other, for example.

The IoC may be provided from a public organization, a vendor, or the like, or may be generated from the aforementioned security report using an existing tool (for example, Threat Report ATT&CK Mapper: TRAM), or, furthermore, it may be written manually. Furthermore, the IoC may be expressed in STIX (Structured Threat Information eXpression), or may include a MITRE ATT&CK Technique ID as TTPs (Tactics, Techniques and. Procedures) (see: https://www.ipa.go.jp/security/vuln/STIX.html).

In addition, as illustrated in FIG. 2, the information analysis apparatus 10 includes a news article collecting unit 13, a search processing unit 14, and an information storage unit 15 in addition to the aforementioned feature information extracting unit 11 and feature information associating unit 12.

The news article collecting unit 13 accesses the news database 20 via the network 40, and collects news articles. News articles to be collected may be news articles published during a designated period, or may be all of the news articles that have not been collected yet. In addition, the news article collecting unit 13 stores the collected news articles to the information storage unit 15.

Specifically, the news article collecting unit 13 crawls the Internet for a news site in accordance with a list of URLs of news sites prepared in advance, and collects news articles. The news article collecting unit 13 can also delete elements of each news article other than the text from the news site and collect only the text by using a processing method defined for the news site. Examples of news article include “malware X cost Company A hundreds of millions of yen”, and the like.

In the example embodiment, the feature information extracting unit 11 first reads out a collected news article from the information storage unit 15. In the example embodiment, the feature information extracting unit 11 then extracts at least one of the name of a victim of a cyberattack, damage details, and a cost of damage from the news article, as feature information.

Specific examples of feature information include the following information. Note that feature information may be information that overlaps technical information. When a news article includes technical information, the feature information extracting unit 11 may extract this technical information as feature information.
Name of victim
Damage details
Cost of damage
Type of article (incident case example, vulnerability information, update information of product, product introduction, service introduction, threat trend, research result, politics trend, etc.)
Name of threat actor
Name of attack campaign
Name of malware
Name of attack tool
Target of attack (product name, service name, site name)
TTPs (Tactics, Techniques and Procedures) information (ATT&CK Tactic and Technique, kill chain stage)
Common Vulnerability and Exposure (CVE)
Name of vulnerability
Indicator information
Observables
Attack date and time

In a case of a news article that is one of the above examples, for example, the feature information extracting unit 11 extracts “Company A (name of victim)”, “hundreds of millions of yen (cost of damage)”, and “malware X (name of software used in cyberattack)” as feature information.

In addition, examples of a feature information extraction technique that is performed by the feature information extracting unit 11 includes the following four extraction techniques. First, a first extraction technique is an extraction technique that uses regular expressions. Assume that a CVE ID, indicator information, date, and the like that are extraction targets are converted into regular expressions, and the regular expressions are registered as feature amounts in advance, for example. In this case, the feature information extracting unit 11 converts each word included in a news article into a regular expression, and, if the obtained regular expression matches a regular expression registered in advance, extracts that word as feature information.

A second extraction technique is an extraction technique that uses a dictionary. Assume that, for example, a dictionary in which the names of threat actors that are extraction targets are registered is prepared in advance. In this case, the feature information extracting unit 11 refers to the dictionary for each word included in a news article, and, if the word matches a registered name of threat actor, extracts that word as feature information. Note that extraction targets registered in the dictionary may be other than the names of threat actors.

A third extraction technique is an extraction technique that uses a trained NER (Named Entity Recognition) model. The NER model is constructed by performing machine learning using, as training data, words that are each provided with a label indicating whether or not the word is an extraction target. The feature information extracting unit 11 inputs words included in a news article to the NER model, and extracts relevant words as feature information based on an output result from the NER model.

A fourth extraction technique is an extraction method that uses a combination of Doc2Vec and a support vector machine (SVM). Doc2Vec is an algorithm for vectorizing word information in text, and Doc2Vec generates, from input text, a vector expression of the text, and outputs the generated vector expression. The support vector machine is constructed by performing machine learning using, as training data, a vector output from Doc2Vec and provided with a label indicating whether or not the vector is an extraction target.

The feature information extracting unit 11 inputs a news article to Doc2Vec, and inputs a vector output from Doc2Vec, to the SVM. The feature information extracting unit 11 then extracts relevant words as feature information based on an output result of the SVM. Note that, in the fourth extraction technique, a machine learning algorithm other than an SVM may be used.

In the example embodiment, the feature information extracting unit 11 can also determine whether or not a news article includes a case example of damage from a cyberattack. In this case, if it is determined that a case example of damage from a cyberattack is included, the feature information extracting unit 11 extracts feature information from the news article.

Specifically, the feature information extracting unit 11 can determine whether or not a news article includes a case example of damage from a cyberattack, using a machine learning model. The machine learning model may be a topic model such as LDA (Latent Dirichlet Allocation). The topic model can be constructed through unsupervised machine learning in which news articles are used as training data.

In addition, a machine learning model for the above determination may also be a combination of Doc2Vec and a support vector machine (SVM), and furthermore, in this case, a machine learning algorithm other than an SVM may be used. In this case, the support vector machine is constructed by performing machine learning by using, as training data, a vector output from Doc2Vec and provided with a label indicating whether or not the vector includes a case example of damage.

In the example embodiment, for example, the feature information associating unit 12 compares the date provided to technical information in the technical information database 30 (specifically, description on the date of IoC) with a publication time and date of a news article. In addition, if the difference between the date provided to the technical information and the publication time and date of the news article is within a set range, the feature information associating unit 12 associates feature information extracted from that news article and that technical information with each other.

In addition, if the feature information extracted by the feature information extracting unit 11 includes technical information, the feature information associating unit 12 may search the technical information database 30 using the technical information included in the feature information, and associate technical information related to the technical information used as a query, with the feature information. A search for technical information may be performed through simple text comparison, or may be performed by vectorizing a search word and a retrieved word, and using cosine similarity between the search word and the retrieved word.

In addition, when technical information includes information regarding vulnerability, the feature information associating unit 12 can specify an event that may be caused by the vulnerability, and associate feature information that includes the specified event with the technical information that includes the information regarding vulnerability. The information regarding vulnerability may be Common Vulnerabilities and Exposures or a vulnerability name.

Furthermore, the feature information associating unit 12 can also calculate the similarity between technical information and feature information associated with each other. Examples of the similarity includes a cosine similarity. In addition, the feature information associating unit 12 can also calculate the similarity using a learning model subjected to machine learning of the similarity between technical information and feature information in advance.

In addition, the feature information associating unit 12 may perform snowball sampling. Specifically, the feature information associating unit 12 associates feature information and technical information with each other using a method such as that described above, and then further searches for relevant technical information or feature information using one of or both the technical information and the feature information associated with each other. The feature information associating unit 12 then recursively associates newly retrieved technical information or feature information with the feature information and technical information associated with each other previously.

Also in a case where association is performed through snowball sampling, the feature information associating unit 12 can obtain the cosine similarity between information, similarly to the above example. In addition, the feature information associating unit 12 can also calculate a cosine similarity for each pair of a search word and a retrieved word that are used in a process of snowball sampling, and handle the calculated similarity as a similarity in snowball sampling.

The feature information associating unit 12 stores technical information and feature information associated therewith to a storage region of a storage unit, that is to say, the information storage unit 15, in a state where the technical information and the feature information are associated with each other. In addition, when a similarity has been calculated as described above, the feature information associating unit 12 can also associate that similarity with the technical information and the feature information.

The search processing unit 14 accepts a search query input via an input apparatus such as a keyboard or an external terminal apparatus, and executes a search for technical information and feature information stored in the information storage unit 15 based on the accepted search query.

Specifically, the search processing unit 14 specifies feature information that matches or is similar to the search query, from the feature information stored in the information storage unit 15, and further specifies technical information associated with the specified feature information. In addition, the search processing unit 14 can also specify technical information that matches or is similar to the search query, from the technical information stored in the information storage unit 15, and specify feature information associated with the specified technical information.

The search processing unit 14 then displays the specified feature information and technical information on the screen of an external display device, the screen of a terminal apparatus, or the like, as a search result. In addition, if a similarity is associated with the technical information and the feature information, the search processing unit 14 also specifies the associated similarity and displays the specified similarity.

[Apparatus Operations]

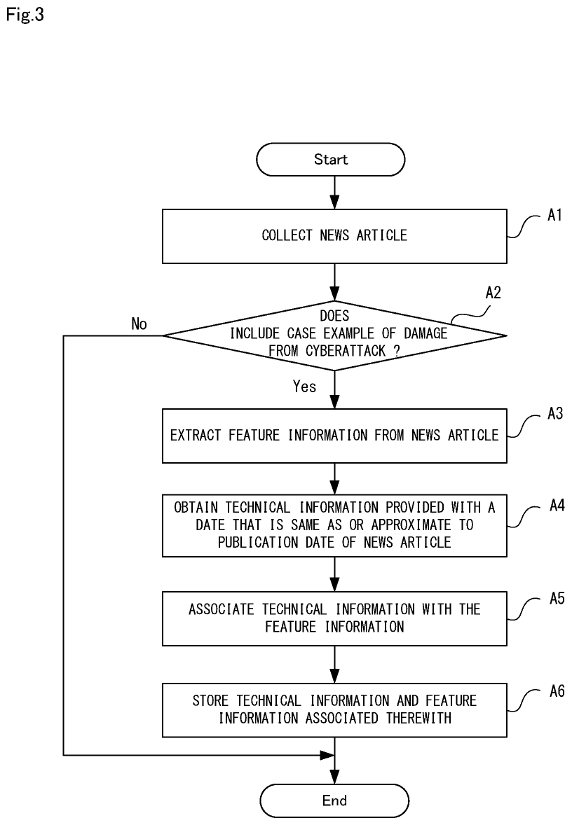

Next, operations of the information analysis apparatus 10 in the example embodiment will be described with reference to FIG. 3. FIG. 3 is a flowchart illustrating operations of the information analysis apparatus according to the example embodiment. In the following description, FIGS. 1 and 2 are referred to as appropriate. In addition, in the example embodiment, an information analysis method is performed by operating the information analysis apparatus 10. Thus, description of the information analysis method in the example embodiment is replaced with the following description of the operations of the information analysis apparatus 10.

As illustrated in FIG. 3, first, the news article collecting unit 13 accesses the news database 20 via the network 40, and collects a news article (step A1). In step A1, for example, a news article published during a designated period is targeted for collecting. The collected news article is stored in the information storage unit 15.

Next, the feature information extracting unit 11 determines whether or not the news article collected in step A1 includes a case example of damage from a cyberattack (step A2). If, as a result of the determination in step A2, the news article collected in step A1 does not include a case example of damage from a cyberattack (step A2: No), processing that is performed by the information analysis apparatus 10 ends.

On the other hand, if, as a result of the determination in step A2, the news article collected in step A1 includes a case example of damage from a cyberattack (step A2: Yes), the feature information extracting unit 11 reads out the news article collected in step A1, from the information storage unit 15. The feature information extracting unit 11 then extracts feature information from the read news article (step A3). In step A3, for example, the name of a victim, damage details, and a cost of damage of a cyberattack are extracted as feature information.

Next, the feature information associating unit 12 obtains, from the technical information database 30, technical information provided with a date that is the same as or approximate to the publication date of the news article from which the feature information was extracted in step A3 (step A4). Note that the date approximate to the publication date indicates that the difference between the publication date and the date approximate to the publication date is within a set range, such as three days or the same month.

Next, the feature information associating unit 12 associates the technical information obtained in step A4, with the feature information extracted in step A3 (step A5). The feature information associating unit 12 then stores, in the information storage unit 15, the technical information and the feature information associated therewith, in a state where the technical information and the feature information are associated with each other (step A6).

After step A6 is completed, when a search query is input via an input apparatus such as a keyboard or an external terminal apparatus, the search processing unit 14 accepts the search query. The search processing unit 14 then specifies feature information that matches or is similar to the search query, from the feature information stored in the information storage unit 15, and further specifies technical information associated with the specified feature information. Subsequently, the search processing unit 14 displays, as a search result, the specified feature information and technical information, on the screen of an external display device, the screen of a terminal apparatus, or the like.

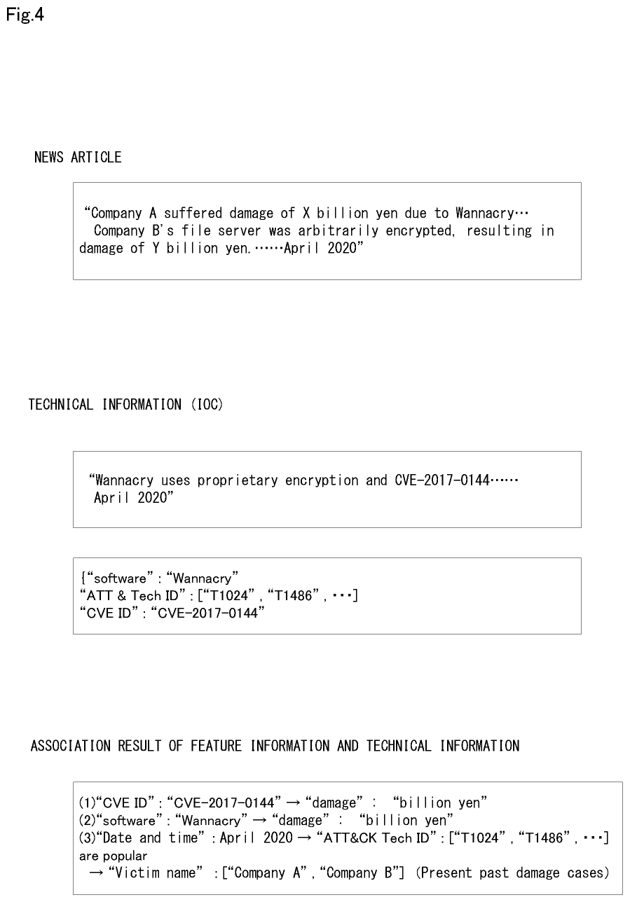

A specific example will be described with reference to FIG. 4. FIG. 4 is a diagram illustrating an example of a news article, an example of technical information, and an example of a result of associating feature information and technical information with each other.

Assume that a news article that includes a case example of damage from a cyberattack as illustrated in the upper section in FIG. 4 has been collected. In addition, assume that, in the technical information database 30, technical information to which the same month as the news article is added, as illustrated in the middle section in FIG. 4, is stored. The technical information may be written in natural language, or may be generated in a structured format.

When there is the news article illustrated in the upper section in FIG. 4, the feature information extracting unit 11 extracts “Wannacry”, “cost of damage: hundreds of millions of yen”, “company A”, “company B”, “file server”, and “encrypted” as feature information. The feature information associating unit 12 then associates the extracted feature information and technical information with each other. As a result, the result illustrated in the lower section in FIG. 4 is obtained.

As described above, according to the example embodiment, feature information extracted from a news article and technical information are associated with each other. Therefore, a searcher can obtain feature information and technical information related to the feature information at the same time, by inputting a search query.

### Modified Example

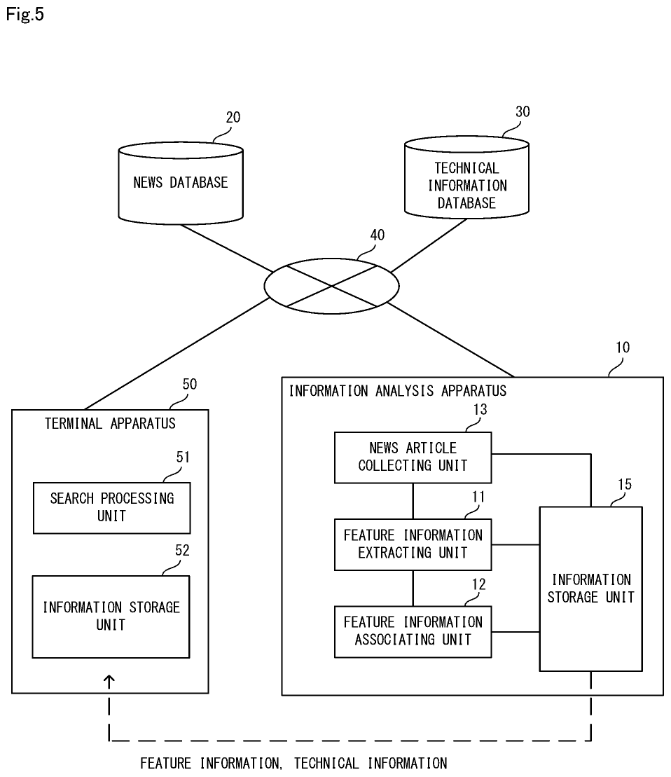

A modified example of the information analysis apparatus 10 according to the example embodiment will be described with reference to FIG. 5. FIG. 5 is a configuration diagram illustrating a configuration of the modified example of the information analysis apparatus according to the example embodiment.

As illustrated in FIG. 5, in the modified example, unlike the example illustrated in FIG. 2, a configuration is adopted in which the information analysis apparatus 10 includes no search processing unit. Except for that, the information analysis apparatus 10 is similar to the example illustrated in FIG. 2.

In the modified example, the information analysis apparatus 10 is connected to a terminal apparatus 50 that is used by a searcher, via the network 40. In addition, the terminal apparatus 50 includes a search processing unit 51 that is similar to the search processing unit 14 illustrated in FIG. 2, and an information storage unit 52.

Next, in the modified example, when feature information and technical information are associated with each other, the information analysis apparatus 10 transmits the associated feature information and technical information to the terminal apparatus 50 via the network 40. When the associated feature information and technical information are transmitted, the terminal apparatus 50 stores the associated feature information and technical information in the information storage unit 52.

With this configuration, a searcher can input a search query on the terminal apparatus 50. In this case, the search processing unit 51 accesses the information storage unit 52 of the terminal apparatus 50, and specifies feature information that matches or is similar to the search query and technical information associated with the feature information, from the feature information stored in the information storage unit 52. Subsequently, the search processing unit 51 displays the specified feature information and technical information, on the screen of the terminal apparatus 50.

According to the modified example, the information analysis apparatus 10 itself does not need to have a search function, and the cost of the information analysis apparatus 10 is decreased. In addition, no search query is transmitted from the terminal apparatus 50 to the information analysis apparatus 10, and thus, according to the modified example, the likelihood of a search query becoming known to the administrator of the information analysis apparatus 10 is eliminated.

[Program]

It suffices for the program according to the example embodiment that causes a computer to carry out steps A1 to A6 illustrated in FIG. 3. By installing this program on a computer and executing the program, the information analysis apparatus 10 and the information analysis method in the example embodiment can be realized. In this case, one or more processors of the computer function and perform processing as the feature information extracting unit 11, the feature information associating unit 12, and the news article collecting unit 13. Furthermore, besides a general-purpose PC, a smartphone and a tablet-type terminal device can be mentioned as examples of the computer.

Furthermore, in the example embodiment, the information storage unit 15 may be realized by storing data files constituting the information storage unit 15 in a storage device such as a hard disk provided in the computer, or may be realized by a storage device provided in another computer.

The program according to the example embodiment may be executed by a computer system constructed from a plurality of computers. In this case, the computers may each function as one of the feature information extracting unit 11, the feature information associating unit 12, and the news article collecting unit 13.

[Physical Configuration]

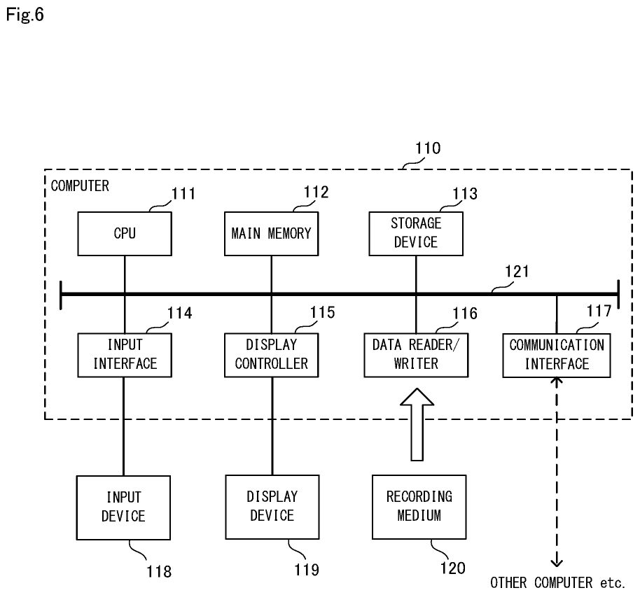

Using FIG. 6, the following describes a computer that realizes the information analysis apparatus 10 by executing the program according to the example embodiment. FIG. 6 is a block diagram illustrating an example of a computer that realizes the information analysis apparatus according to the example embodiment.

As illustrated in FIG. 6, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the information analysis apparatus 10 can also be realized by using items of hardware that respectively correspond to the components rather than the computer in which the program is installed. Furthermore, a part of the information analysis apparatus 10 may be realized by the program, and the remaining part of the information analysis apparatus 10 may be realized by hardware.

A part or an entirety of the above-described example embodiment can be represented by (Supplementary Note 1) to (Supplementary Note 21) described below but is not limited to the description below.

(Supplementary Note 1)

An information analysis apparatus comprising:

a feature information extracting unit that extracts feature information indicating a characteristic item in a cyberattack, from a news article; and

a feature information associating unit that extracts, from a database storing technical information regarding a cyberattack that has already occurred, technical information related to the extracted feature information, and associates the extracted feature information and the extracted technical information with each other.

(Supplementary Note 2)

The information analysis apparatus according to Supplementary Note 1,

wherein the feature information extracting unit extracts at least one of a victim name, damage details, and a damage cost of the cyberattack as the feature information from the news article.

(Supplementary Note 3)

The information analysis apparatus according to Supplementary Note 1 or 2,

wherein the feature information extracting unit determines whether or not the news article includes a case example of damage from a cyberattack, and extracts the feature information from the news article if a result of the determination indicates that a case example of damage from a cyberattack is included.

(Supplementary Note 4)

The information analysis apparatus according to any one of Supplementary Notes 1 to 3,

wherein the feature information associating unit stores, in a storage region of a storage device, the technical information and the feature information associated therewith in a state where the technical information and the feature information are associated with each other.

(Supplementary Note 5)

The information analysis apparatus according to any one of Supplementary Notes 1 to 4,

wherein the feature information associating unit compares a date provided to the technical information in the database with a publication date and time of the news article, and associates the feature information extracted from the news article with the technical information if a difference between the date provided to the technical information and the publication date and time of the news article is within a set range.

(Supplementary Note 6)

The information analysis apparatus according to any one of Supplementary Notes 1 to 5,

wherein the technical information includes at least one of information regarding vulnerability of an attacked system, a name of software used in a cyberattack, and cyberattack TTPs.

(Supplementary Note 7)

The information analysis apparatus according to any one of Supplementary Notes 1 to 6,

wherein, if the technical information includes information regarding vulnerability, the feature information associating unit specifies an event that is caused by the vulnerability, and associates feature information that includes the specified event with the technical information that includes the information regarding vulnerability.

(Supplementary Note 8)

An information analysis method comprising:

a feature information extracting step of extracting feature information indicating a characteristic item in a cyberattack, from a news article; and

a feature information associating step of extracting, from a database storing technical information regarding a cyberattack that has already occurred, technical information related to the extracted feature information, and associating the feature information and the technical information with each other.

(Supplementary Note 9)

The information analysis method according to Supplementary Note 8,

wherein, in the feature information extracting step, at least one of a victim name, damage details, and a damage cost of the cyberattack is extracted as the feature information from the news article.

(Supplementary Note 10)

The information analysis method according to Supplementary Note 8 or 9,

wherein, in the feature information extracting step, determination is performed as to whether or not the news article includes a case example of damage from a cyberattack, and the feature information is extracted from the news article if a result of the determination indicates that a case example of damage from a cyberattack is included.

(Supplementary Note 11)

The information analysis method according to any one of Supplementary Notes 8 to 10,

wherein, in the feature information associating step, the technical information and the feature information associated therewith are stored in a storage region of a storage device in a state where the technical information and the feature information are associated with each other.

(Supplementary Note 12)

The information analysis method according to any one of Supplementary Notes 8 to 11,

wherein, in the feature information associating step, a date provided to the technical information in the database is compared with a publication date and time of the news article, and the feature information extracted from the news article is associated with the technical information if a difference between the date provided to the technical information and the publication date and time of the news article is within a set range.

(Supplementary Note 13)

The information analysis method according to any one of Supplementary Notes 8 to 12,

wherein the technical information includes at least one of information regarding vulnerability of an attacked system, a name of software used in a cyberattack, and cyberattack TTPs.

(Supplementary Note 14)

The information analysis method according to any one of Supplementary Notes 8 to 13,

wherein, in feature information associating step, if the technical information includes information regarding vulnerability, an event that is caused by the vulnerability is specified, and feature information that includes the specified event is associated with the technical information that includes the information regarding vulnerability.

(Supplementary Note 15)

A computer-readable recording medium that includes a program recorded thereon, the program including instructions that cause a computer to carry out:

a feature information extracting step of extracting feature information indicating a characteristic item in a cyberattack, from a news article; and

a feature information associating step of extracting, from a database storing technical information regarding a cyberattack that has already occurred, technical information related to the extracted feature information, and associating the feature information and the technical information with each other.

(Supplementary Note 16)

The computer-readable recording medium according to Supplementary Note 15,

wherein, in the feature information extracting step, at least one of a victim name, damage details, and a damage cost of the cyberattack is extracted as the feature information from the news article.

(Supplementary Note 17)

The computer-readable recording medium according to Supplementary Note 15 or 16,

wherein, in the feature information extracting step, determination is performed as to whether or not the news article includes a case example of damage from a cyberattack, and the feature information is extracted from the news article if a result of the determination indicates that a case example of damage from a cyberattack is included.

(Supplementary Note 18)

The computer-readable recording medium according to any one of Supplementary Notes 15 to 17,

wherein, in the feature information associating step, the technical information and the feature information associated therewith are stored in a storage region of a storage device in a state where the technical information and the feature information are associated with each other.

(Supplementary Note 19)

The computer-readable recording medium according to any one of Supplementary Notes 15 to 18,

wherein, in the feature information associating step, a date provided to the technical information in the database is compared with a publication date and time of the news article, and the feature information extracted from the news article is associated with the technical information if a difference between the date provided to the technical information and the publication date and time of the news article is within a set range.

(Supplementary Note 20)

The computer-readable recording medium according to any one of Supplementary Notes 15 to 19,

wherein the technical information includes at least one of information regarding vulnerability of an attacked system, a name of software used in a cyberattack, and cyberattack TTPs.

(Supplementary Note 21)

The computer-readable recording medium according to any one of Supplementary Notes 15 to 20,

wherein, in the feature information associating step, if the technical information includes information regarding vulnerability, an event that is caused by the vulnerability is specified, and feature information that includes the specified event is associated with the technical information that includes the information regarding vulnerability.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

According to the invention, it is possible to obtain characteristic information regarding a cyberattack along with technical information regarding a cyberattack. The present invention is useful in various fields where analysis of cyberattacks is required.

### REFERENCE SIGNS LIST

10 Information analysis apparatus
11 Feature information extracting unit
12 Feature information associating unit
13 News article collecting unit
14 Search processing unit
15 Information storage unit
16 Information storage unit
20 News database
30 Technical information database
40 Network
50 Terminal apparatus
51 Search processing unit
52 Information storage unit
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An information analysis apparatus comprising:
at least one memory storing instructions; and
at least one processor configured to execute the instructions to:
extract feature information indicating a characteristic item in a cyberattack, from a news article; and
extract, from a database storing technical information regarding a cyberattack that has already occurred, technical information related to the extracted feature information, and associate the extracted feature information and the extracted technical information with each other.

2. The information analysis apparatus according to claim 1,
further at least one processor configured to execute the instructions to:
extract at least one of a victim name, damage details, and a damage cost of the cyberattack as the feature information from the news article.

3. The information analysis apparatus according to claim 1,
further at least one processor configured to execute the instructions to:
determine whether or not the news article includes a case example of damage from a cyberattack, and extract the feature information from the news article if a result of the determination indicates that a case example of damage from a cyberattack is included.

4. The information analysis apparatus according to claim 1,
further at least one processor configured to execute the instructions to:
store, in a storage region of a storage device, the technical information and the feature information associated therewith in a state where the technical information and the feature information are associated with each other.

5. The information analysis apparatus according to claim 1,
further at least one processor configured to execute the instructions to:
wherein the feature information associating means compares a date provided to the technical information in the database with a publication date and time of the news article, and associates the feature information extracted from the news article with the technical information if a difference between the date provided to the technical information and the publication date and time of the news article is within a set range.

6. The information analysis apparatus according to claim 1,
wherein the technical information includes at least one of information regarding vulnerability of an attacked system, a name of software used in a cyberattack, and cyberattack TTPs.

7. The information analysis apparatus according to claim 1,
further at least one processor configured to execute the instructions to:
specify, if the technical information includes information regarding vulnerability, an event that is caused by the vulnerability, and associate feature information that includes the specified event with the technical information that includes the information regarding vulnerability.

8. An information analysis method comprising:
extracting feature information indicating a characteristic item in a cyberattack, from a news article; and
extracting, from a database storing technical information regarding a cyberattack that has already occurred, technical information related to the extracted feature information, and associating the feature information and the technical information with each other.

9. The information analysis method according to claim 8,
wherein, in the extraction of the feature information, at least one of a victim name, damage details, and a damage cost of the cyberattack is extracted as the feature information from the news article.

10. The information analysis method according to claim 8,
wherein, in the extraction of the feature information, determination is performed as to whether or not the news article includes a case example of damage from a cyberattack, and the feature information is extracted from the news article if a result of the determination indicates that a case example of damage from a cyberattack is included.

11. The information analysis method according to claim 8,
wherein, in the association of the feature information, the technical information and the feature information associated therewith are stored in a storage region of a storage device in a state where the technical information and the feature information are associated with each other.

12. The information analysis method according to claim 8,
wherein, in the association of the feature information, a date provided to the technical information in the database is compared with a publication date and time of the news article, and the feature information extracted from the news article is associated with the technical information if a difference between the date provided to the technical information and the publication date and time of the news article is within a set range.

13. The information analysis method according to claim 8,
wherein the technical information includes at least one of information regarding vulnerability of an attacked system, a name of software used in a cyberattack, and cyberattack TTPs.

14. The information analysis method according to claim 8,
wherein, in the association of the feature information, if the technical information includes information regarding vulnerability, an event that is caused by the vulnerability is specified, and feature information that includes the specified event is associated with the technical information that includes the information regarding vulnerability.

15. A non-transitory computer-readable recording medium that includes a program recorded thereon, the program including instructions that cause a computer to carry out the steps of:
extracting feature information indicating a characteristic item in a cyberattack, from a news article; and
extracting, from a database storing technical information regarding a cyberattack that has already occurred, technical information related to the extracted feature information, and associating the feature information and the technical information with each other.

16. The non-transitory computer-readable recording medium according to claim 15,
wherein, in the extraction of the feature information, at least one of a victim name, damage details, and a damage cost of the cyberattack is extracted as the feature information from the news article.

17. The non-transitory computer-readable recording medium according to claim 15,
wherein, in the extraction of the feature information, determination is performed as to whether or not the news article includes a case example of damage from a cyberattack, and the feature information is extracted from the news article if a result of the determination indicates that a case example of damage from a cyberattack is included.

18. The non-transitory computer-readable recording medium according to claim 15,
wherein, in the association of the feature information, the technical information and the feature information associated therewith are stored in a storage region of a storage device in a state where the technical information and the feature information are associated with each other.

19. The non-transitory computer-readable recording medium according to claim 15,
wherein, in the association of the feature information, a date provided to the technical information in the database is compared with a publication date and time of the news article, and the feature information extracted from the news article is associated with the technical information if a difference between the date provided to the technical information and the publication date and time of the news article is within a set range.

20. The non-transitory computer-readable recording medium according to claim 15,
wherein the technical information includes at least one of information regarding vulnerability of an attacked system, a name of software used in a cyberattack, and cyberattack TTPs.

21. The non-transitory computer-readable recording medium according to claim 15,
wherein, in the association of the feature information, if the technical information includes information regarding vulnerability, an event that is caused by the vulnerability is specified, and feature information that includes the specified event is associated with the technical information that includes the information regarding vulnerability.
